(19) United States
(12) Patent Application Publication
(10) Pub. No.: US 2008/0107116 A1
(43) Pub. Date: May 8, 2008

(54) Large scale multi-processor system with a link-level interconnect providing in-order packet delivery

(75) Inventors: Nitin Godiwala, Boylston, MA (US); Judson S. Leonard, Newton, MA (US); Matthew H. Reilly, Stow, MA (US); Lawrence C. Stewart, Wayland, MA (US)

Correspondence Address: WILMERHALE/BOSTON, 60 STATE STREET, BOSTON, MA, 02109, US

(73) Assignee: SiCortex, Inc.

(21) Appl. No.: 11/594,421

(22) Filed: Nov. 8, 2006

(51) Int. Cl. H04L 12/56

(52) U.S. Cl. 370/394; 370/401

(57) ABSTRACT

A large-scale multiprocessor system with a link-level interconnect that provides in-order packet delivery. The method comprises transmitting, over a link in the defined interconnection topology, a sequence of packets in a defined order from a first node to a second node. The second node is an intermediate node in a route between the first and third node. At the first node, the transmitted packets are stored in a buffer. In response to an error in reception, the first node retrieves packets from the buffer and re-transmits them to the second node, beginning with the packet subsequent to the last packet in the sequence correctly received by the second node and continuing through the remainder of the sequence of packets.

### CROSS-REFERENCE TO RELATED APPLICATIONS

This application is related to the following U.S. patent applications, the contents of which are incorporated herein in their entirety by reference:

U.S. patent application Ser. No. 11/335421, filed Jan. 19, 2006, entitled SYSTEM AND METHOD OF MULTI-CORE CACHE COHERENCY;

U.S. patent application Ser. No. TBA, filed on an even date herewith, entitled COMPUTER SYSTEM AND METHOD USING EFFICIENT MODULE AND BACKPLANE TILING TO INTERCONNECT COMPUTER NODES VIA A KAUTZ-LIKE DIGRAPH;

U.S. patent application Ser. No. TBA, filed on an even date herewith, entitled SYSTEM AND METHOD FOR PREVENTING DEADLOCK IN RICHLY-CONNECTED MULTI-PROCESSOR COMPUTER SYSTEM USING DYNAMIC ASSIGNMENT OF VIRTUAL CHANNELS;

U.S. patent application Ser. No. TBA, filed on an even date herewith, entitled MESOCHRONOUS CLOCK SYSTEM AND METHOD TO MINIMIZE LATENCY AND BUFFER REQUIREMENTS FOR DATA TRANSFER IN A LARGE MULTI-PROCESSOR COMPUTING SYSTEM;

U.S. patent application Ser. No. TBA, filed on an even date herewith, entitled REMOTE DMA SYSTEMS AND METHODS FOR SUPPORTING SYNCHRONIZATION OF DISTRIBUTED PROCESSES IN A MULTIPROCESSOR SYSTEM USING COLLECTIVE OPERATIONS;

U.S. patent application Ser. No. TBA, filed on an even date herewith, entitled COMPUTER SYSTEM AND METHOD USING A KAUTZ-LIKE DIGRAPH TO INTERCONNECT COMPUTER NODES AND HAVING CONTROL BACK CHANNEL BETWEEN NODES;

U.S. patent application Ser. No. TBA, filed on an even date herewith, entitled SYSTEM AND METHOD FOR ARBITRATION FOR VIRTUAL CHANNELS TO PREVENT LIVELOCK IN A RICHLY-CONNECTED MULTI-PROCESSOR COMPUTER SYSTEM;

U.S. patent application Ser. No. TBA, filed on an even date herewith, entitled LARGE SCALE COMPUTING SYSTEM WITH MULTI-LANE MESOCHRONOUS DATA TRANSFERS AMONG COMPUTER NODES;

U.S. patent application Ser. No. TBA, filed on an even date herewith, entitled SYSTEM AND METHOD FOR COMMUNICATING ON A RICHLY CONNECTED MULTI-PROCESSOR COMPUTER SYSTEM USING A POOL OF BUFFERS FOR DYNAMIC ASSOCIATION WITH A VIRTUAL CHANNEL;

U.S. patent application Ser. No. TBA, filed on an even date herewith, entitled RDMA SYSTEMS AND METHODS FOR SENDING COMMANDS FROM A SOURCE NODE TO A TARGET NODE FOR LOCAL EXECUTION OF COMMANDS AT THE TARGET NODE;

U.S. patent application Ser. No. TBA, filed on an even date herewith, entitled SYSTEMS AND METHODS FOR REMOTE DIRECT MEMORY ACCESS TO PROCESSOR CACHES FOR RDMA READS AND WRITES; and

U.S. patent application Ser. No. TBA, filed on an even date herewith, entitled SYSTEM AND METHOD FOR REMOTE DIRECT MEMORY ACCESS WITHOUT PAGE LOCKING BY THE OPERATING SYSTEM.

### BACKGROUND OF THE INVENTION

1. Field of the Invention

The invention relates generally to an interconnect system for a large scale multiprocessor system, and more specifically, to an interconnect system for a large scale multiprocessor system with a reliable link-level interconnection which preserves in order packet delivery among nodes.

2. Description of the Related Art

Massively parallel computing systems have been proposed for scientific computing and other compute-intensive applications. The computing system typically includes many nodes, and each node may contain several processors. Various forms of interconnect topologies have been proposed to connect the nodes, including Hypercube topologies, butterfly and omega networks, tori of various dimensions, fat trees, and random networks.

Scientific and other computer systems have relied on networking technologies so that the computer nodes may send messages among one another. Many modern computer networks use a layered approach such as the OSI 7-layer model. Conventionally, computer operating systems include networking software to support a layered model.

The lowest layer (layer 1) is typically reserved for the physical layer, i.e., the actual hardware communication medium for the network. A link layer (layer 2) resides above the physical layer and is typically responsible for sending data between two nodes or entities that are physically connected. A network layer (layer 3) allows communication in larger networks, so that one node may communicate with another even if they are not directly physically connected. Internet Protocol (or IP) is perhaps the most popular network layer. A transport protocol (layer 4) provides still higher level functionality to the model, and so on up the model's stack until the application layer (layer 7) is reached.

The transmission control protocol (TCP) is a popular connection-based transport protocol (layer 4). TCP ensures that messages sent from a sending node to a receiving node will be presented to the upper layers of the receiving node reliably and in the exact order they were sent. It does this by having the sending node segment large messages into smaller-sized packets each identified with a packet identifier. At the receiving node, the packets are re-assembled to their original order (even if they did not arrive in order due to network errors, congestion, or the like).

### SUMMARY OF THE INVENTION

The invention relates generally to a large scale multiprocessor system with a link-level interconnect that provides in-order packet delivery.

One aspect of the invention is a method for providing in-order delivery of link-level packets in a multiprocessor computer system. This system has a large plurality of processing nodes interconnected by a defined interconnection topology. The method relates to a network transmission between a first node and a third node of a multiprocessor computer system, and comprises transmitting, over a link in the defined interconnection topology, a sequence of packets in a defined order from a first node to a second node. The second node is an intermediate node in a route between the first and third node. At the first node, the transmitted packets are stored in a buffer. The first node also receives status information from the second node indicating the last packet in the sequence correctly received by the second node and indicating that an error in reception has been detected by the second node. In response to an error in reception, the first node retrieves packets from the buffer and re-transmits them to the second node, beginning with the packet subsequent to the last packet in the sequence correctly received by the second node and continuing through the remainder of the sequence of packets.

In other aspects of the invention, the packet transmission is done on a unidirectional data link from the first node to the second node, and acknowledgements are received on a separate unidirectional control link from the second node to the first. In yet other aspects of the invention, transmission errors are detected using a CRC code, or by detecting an illegal 10 bit code.

### BRIEF DESCRIPTION OF THE DRAWINGS

Various objects, features, and advantages of the present invention can be more fully appreciated with reference to the following detailed description of the invention when considered in connection with the following drawings, in which like reference numerals identify like elements:

FIGS. 1A-1B are exemplary, simple Kautz topologies;

FIG. 2 shows the architecture of a single node of a large scale multiprocessor system;

FIG. 3 shows an exemplary information flow between nodes;

FIG. 4 shows a detailed block diagram of the link level recovery system;

FIG. 5 shows a flow diagram of the processing at the transmitting end of a link; and

FIG. 6 shows a flow diagram of the processing at the receiving end of a link.

### DETAILED DESCRIPTION OF EMBODIMENTS OF THE INVENTION

Preferred embodiments of the invention provide a reliable link-level interconnect in large scale multiprocessor systems. The link-level interconnect ensures that all packets will be delivered in order between two physically connected nodes. Among other things, the system may exploit such reliability by using lighter protocol stacks that don't need to check for and reassemble lower level packets to place them in order for applications or the like.

Certain embodiments of the invention are utilized on a large scale multiprocessor computer system in which computer processing nodes are interconnected in a Kautz interconnection topology. Kautz interconnection topologies are unidirectional, directed graphs (digraphs). Kautz digraphs are characterized by a degree k and a diameter n. The degree of the digraph is the maximum number of arcs (or links or edges) input to or output from any node. The diameter is the maximum number of arcs that must be traversed from any node to any other node in the topology.

The order O of a graph is the number of nodes it contains. The order of a Kautz digraph is (k+1)kⁿ⁻¹. The diameter of a Kautz digraph increases logarithmically with the order of the graph.

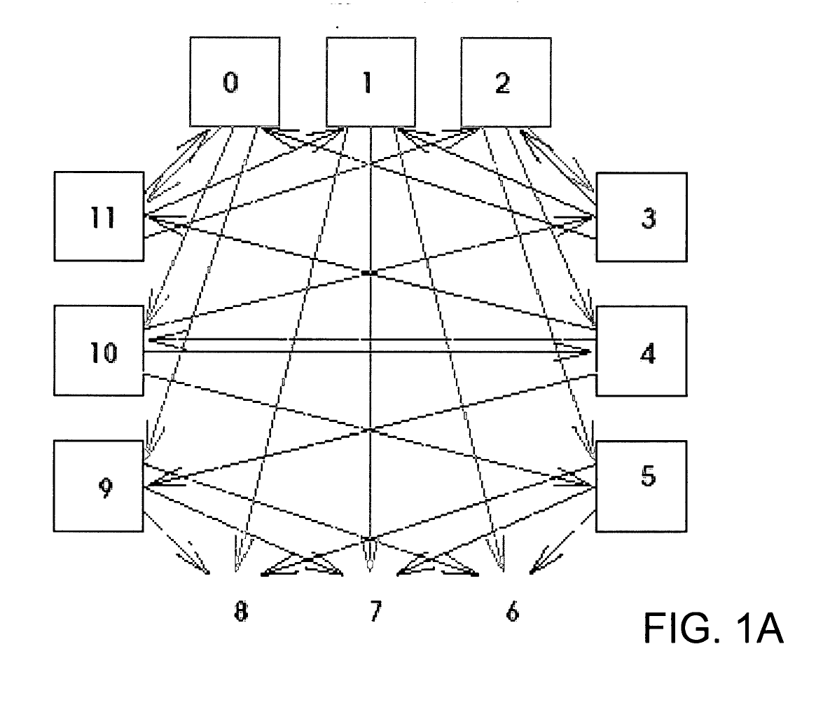

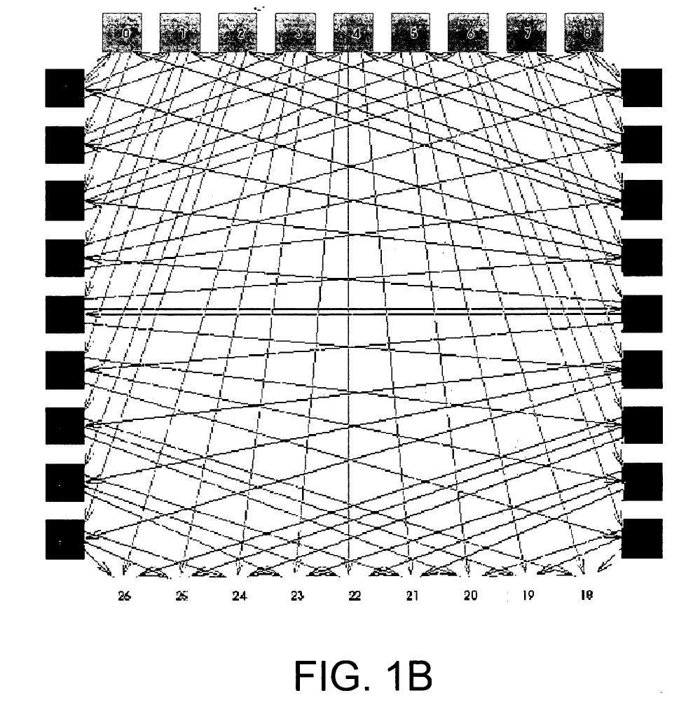

FIG. 1A depicts a very simple Kautz topology for descriptive convenience. The system is order 12 and diameter 2. By inspection, one can verify that any node can communicate with any other node in a maximum of 2 hops. FIG. 1B shows a system that is degree three, diameter three, order 36. One quickly sees that the complexity of the system grows quickly. It would be counter-productive to depict and describe preferred systems such as those having hundreds of nodes or more.

The table below shows how the order O of a system changes as the diameter n grows for a system of fixed degree k.

| | Order | | |
|---|---|---|---|
| Diameter (n) | k = 2 | k = 3 | k = 4 |
| 3 | 12 | 36 | 80 |
| 4 | 24 | 108 | 320 |
| 5 | 48 | 324 | 1280 |
| 6 | 96 | 972 | 5120 |

If the nodes are numbered from zero to O−1, the digraph can be constructed by running a link from any node x to any other node y that satisfies the following equation:

y=(−x*k−j)mod O, where 1≦j≦k (1)

Thus, any (x,y) pair satisfying (1) specifies a direct egress link from node x. For example, with reference to FIG. 1B, node 1 has egress links to the set of nodes 30, 31 and 32. Iterating through this procedure for all nodes in the system will yield the interconnections, links, arcs or edges needed to satisfy the Kautz topology. (As stated above, communication between two arbitrarily selected nodes may require multiple hops through the topology but the number of hops is bounded by the diameter of the topology.)

Each node on the system may communicate with any other node on the system by appropriately routing messages onto the communication fabric via an egress link. Moreover, node to node transfers may be multi-lane mesochronous data transfers using 8B/10B codes. Under certain embodiments, any data message on the fabric includes routing information in the header of the message (among other information). The routing information specifies the entire route of the message. In certain degree three embodiments, the routing information is a bit string of 2-bit routing codes, each routing code specifying whether a message should be received locally (i.e., this is the target node of the message) or identifying one of three egress links. Naturally other topologies may be implemented with different routing codes and with different structures and methods under the principles of the invention.

Under certain embodiments, each node has tables programmed with the routing information. For a given node x to communicate with another node z, node x accesses the table and receives a bit string for the routing information. As will be explained below, this bit string is used to control various switches along the message's route to node z, in effect specifying which link to utilize at each node during the route. Another node j may have a different bit string when it needs to communicate with node z, because it will employ a different route to node z and the message may utilize different links at the various nodes in its route to node z. Thus, under certain embodiments, the routing information is not literally an “address” (i.e., it doesn't uniquely identify node z) but instead is a set of codes to control switches for the message's route.

Under certain embodiments, the routes are determined a priori based on the interconnectivity of the Kautz topology as expressed in equation 1. That is, the Kautz topology is defined, and the various egress links for each node are assigned a code (i.e., each link being one of three egress links). Thus, the exact routes for a message from node x to node y are known in advance, and the egress link selections may be determined in advance as well. These link selections are programmed as the routing information. This routing is described in more detail in the related and incorporated patent applications, for example, the application entitled “Computer System and Method Using a Kautz-like Digraph to interconnect Computer Nodes and having Control Back Channel between nodes,” which is incorporated by reference into this application.

### Overview of Nodes and Packet Transmissions

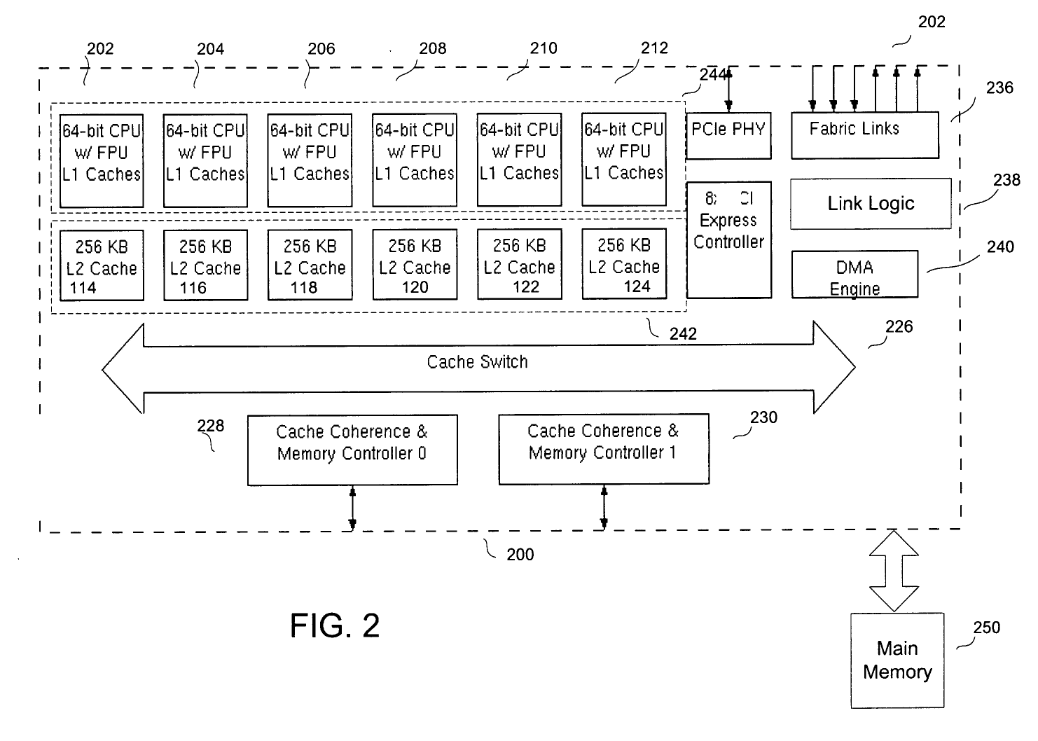

FIG. 2 depicts the architecture of a single node according to certain embodiments of the invention. A large scale multiprocessor system may incorporate many thousands of such nodes interconnected in a predefined topology. Node 200 has six processors 202, 204, 206, 208, 210, and 212. Each processor has a Level 1 cache (grouped as 244) and Level 2 cache (grouped as 242). The node also has main memory 250, cache switch 226, memory controllers 228 and 230, DMA engine 240, link logic 238, and input and output links 236. The output links are 8 bit wide (8 lanes) with a serializer and deserializer at each end of each lane. Each link also has a 1 bit wide link, called the control link for conveying control information. Data on the links is encoded using an 8B/10B code.

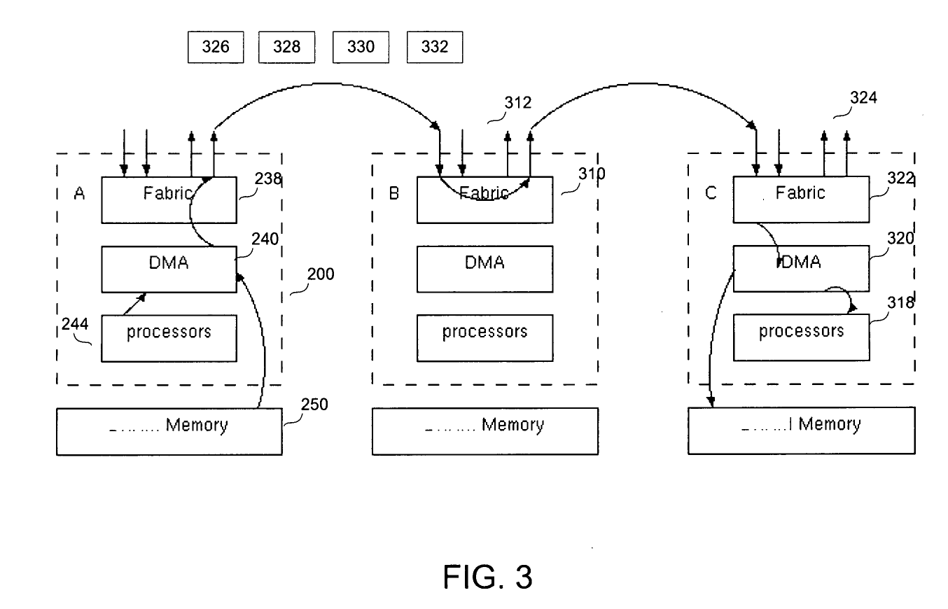

FIG. 3 depicts an exemplary information flow for a message being transferred from a sending node A to a receiving node C. Because of the interconnection topology (see above), node A is not directly connected to node C, and thus the message has to be delivered through other node(s) (i.e., node B) in the interconnection topology.

In this example, one of the processors 244 of node 200 gives a command to the DMA engine 240 on the same node. The DMA engine interprets the command and requests the required data from the memory system. Once the request has been filled and the DMA engine has the data, the DMA engine builds packets 326-332 to contain the message. The packets 326-332 are then transferred to link logic 238 for transmission on the output links 236 which are connected to the input links of Node B 312. In this example, the link logic at node B will analyze the packets and realize that the packets are not intended for local consumption and that they should instead be forwarded along on node B's output links that are connected to node C. The link logic at node C will realize that the packets are intended for local consumption, and the message will be handled by node C's DMA engine 320. The communication from node A to B, and from node B to C are each link-level transmissions. The transmission from node A to C is a network-level transmission.

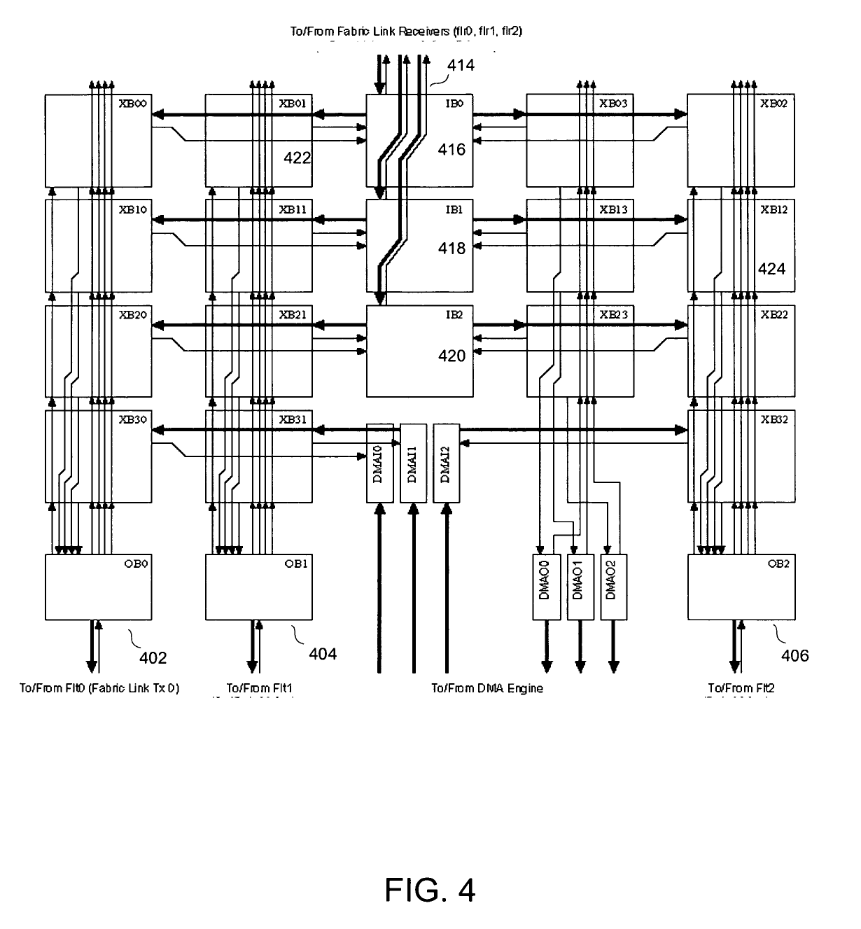

FIG. 4 is a block diagram of one embodiment of the link logic. The link logic has three input links 414 corresponding to a Kautz graph of degree three. The links 414 are connected to three corresponding input blocks 416, 418, and 420. Each of the input blocks is responsible for handling data received on the input data links (shown in heavier line shade) and providing control and status information to a parent node on the control channel (shown in lighter line shade).

More particularly, the input blocks (IBxs) receive incoming packets and store them in a corresponding crosspoint buffer XBxx, such as XB 422, based upon a packet's incoming and outgoing link. For example, a packet arriving on link 1, and leaving on link 2 (determinable from the message header) would be transferred to crosspoint buffer (XB) 1, 2 or XB12 (item 424). The link logic also has three output blocks 402, 404, and 406 for transmitting messages on the output links of a node.

### Error Detection and Recovery on a Link

Under preferred embodiments of the invention, the IBx and OBx of a corresponding link each include logic that cooperates with the other to provide in order delivery of packets. This in order delivery is performed at the link level and allows higher layer protocols to operate more efficiently. For example, higher layer networking software does not need to assume the possibility of out of order delivery and test for such and re-assemble packets.

Each packet forming a message has a packet header, packet body (or payload), and packet trailer. Each packet header contains a virtual channel number, routing information, and a link sequence number (LSN).

The virtual channel number is used to facilitate communication among the nodes, for example, to avoid deadlock. The incorporated, related patent applications discuss this in more detail.

The routing information is used to control the transmission of the packet from node A to eventual target node C. Routing information is read by the link logic at each node as a packet is being routed from link to link on the way to its destination, and is used to determine when a packet has reached its final destination. In the case of a degree 3 Kautz topology, it can be in the form of a string of 2 bit codes identifying the number of the link to use. This too is described in more detail in the incorporated, related patent applications.

The link sequence number is used, among other reasons, to provide for flow control and to ensure that in order delivery of packets at a link level can be maintained. The error detection and recovery methods apply to each link along a packet's route to its destination.

During normal operation, the output block (or transmitter) receives packets for transmission, stores them in a history buffer (or replay buffer), and transmits the packets over the links to another node. The input block (or receiver) at the receiving node checks each packet for errors as it is received. The receiver sends status information back to the transmitting output block on the control channel link in 414 periodically (e.g., as often as possible), and the status information contains, among other things, the LSN of the last correctly received packet from the transmitter. The transmitter uses the LSN from the status packet to correspondingly clear its history buffer. That is, all packets up to and including that LSN are now correctly received at the receiver, so the transmitter no longer needs to maintain a copy of them in its history/replay buffer.

If an error is detected in a packet, the input block will notify the output block of the parent node of the error, indicating the error and the last correctly received packet by LSN. In response, the output block will resend all packets subsequent to the last one correctly received as stored in the replay buffer. At the input block, all packets subsequent to the last packet correctly received are discarded, or ignored, until the input block correctly receives a packet with the LSN expected next after the last one correctly received. Once the next expected packet is correctly received, normal operation resumes at the input block, and subsequent packets are processed and acknowledged normally.

Errors in the transmission of packets on the links may be caused by many problems, including signal attenuation, noise, and varying voltages and temperatures at the receiver and transmitter. Errors may cause packets to have incorrect bits. Errors in a link itself can be detected by detecting a loss of lock in the phase lock loop, by an illegal 10 bit symbol, by a disparity error on any of the 8 lanes of a link, or by loss of heartbeat on the control channel. Errors can also be detected in the received data by an incorrect CRC or a packet length error.

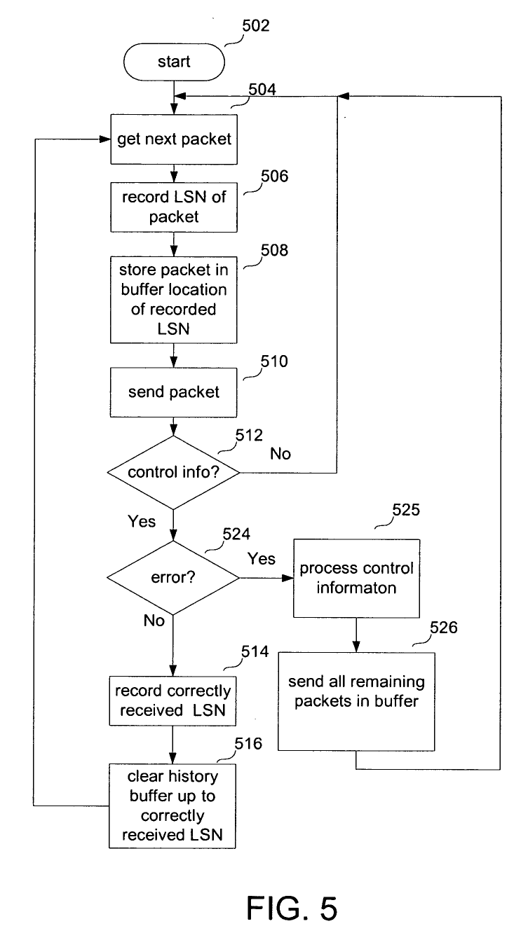

FIG. 5 shows the logic flow of the output block. During normal operation, the output block, receives packets at step 504 from the cross point buffers, such as buffer 422, or via a cut-through transfer. (This is a consequence of arbitration for the output link; this aspect is described in the related, incorporated patent applications.)

At step 506, the output block assigns a LSN for the packet and places it in the packet header. LSNs are assigned sequentially on a link (node-to-node connection) basis. At step 508, the output block stores a copy of the packet in a history buffer location corresponding to the assigned LSN. For example, if the LSN is 4 bits, then the history buffer has 16 locations, one for each possible LSN. At step 510, the packet is serialized, and encoded with an 8B/10B code for transmission over fabric links 202. (Though shown sequentially in the flow, there may be overlap in processing 508 and 510.)

At step 512, the transmitter checks for packets of control information received on the control link. If no control information is received (or the control information is corrupted), the transmitter repeats the process of getting packets from the relevant crosspoint buffers and transmitting them on the output link associated with the output block. (This check for control in certain embodiments is done in parallel with the transfer of data packets.)

If control information is received, the flow proceeds to step 524. There the control status packet is checked to see it is reporting an error. If there is no error flag set in the control packet, then in step 514, the output block records this LSN, and in step 516, the output block clears the history buffer up to and including that LSN recorded in the control packet.

For example, if the output block sends packets 1, 2, 3, 4, and 5, and packet 3 was acknowledged as correctly received, then the output block would remove entries 1, 2, and 3 from its history buffer. If a LSN cannot be assigned because the history buffer is full, then the output block waits until control information is received so that entries in the history buffer can be freed.

If in step 524, an error is reported, the logic proceeds to step 525 where the control packet is processed. The control packet will record the last correctly received packet's LSN and also indicate the type of error. In addition, the error is acknowledged by the output block sending an idle packet with an error acknowledgement flag set. The logic will proceed to step 526 which will replay, or resend, packets in the replay buffer starting with the packet after the last correctly received packet. Thus, using the example above, if packets 1-5 are sent (and stored in the replay buffer) and a control packet is received indicating LSN is equal to 3 but an error has been detected, the output block will resend both packets 4 and 5 (it will also clear out buffer entries for 1-3 if it has not done so already). While the output buffer is resending packets, the output block is concurrently processing control packets.

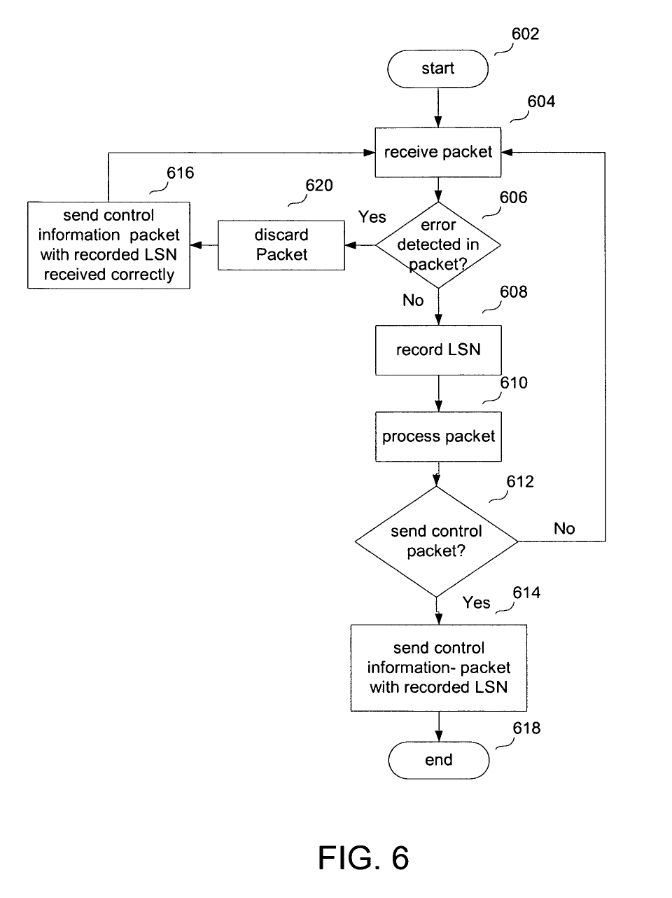

FIG. 6 depicts the logic flow of the input block. Upon receipt of a packet at step 604, the input block checks it for errors at step 606. The types of errors (for certain embodiments) were discussed above, e.g., CRC errors, PLL synchronization errors, etc. If no errors are detected, the LSN of the packet is recorded at step 608. At step 610 the packet is processed normally, such as, determining routing information and forwarding the packet to a crosspoint buffer. At step 612, it is determined whether a control packet may be sent back to the output block. In certain embodiments control packets are sent as often as possible, but it is not guaranteed that a control packet will be sent in response to each and every received packet. (In certain embodiments, the scheduling and processing of control packets may be operated independently and concurrently of data reception.)

If a control packet is to be sent to the output block, the logic proceeds to step 614 where the recorded LSN and other status information (e.g., the error flag and buffer status) are encapsulated in a control packet and sent to the output block via the back channel control link between the nodes.

If an error is detected at step 606, the input block stops accepting traffic until the next expected packet is received at step 620, and sends control information to the output block at step 616. The control packet will indicate the error and indicate the last correctly received packet.

All packets received subsequently at the input block are ignored until the next expected packet is correctly received. This step is not shown separately in the control flow and may be implemented in the receive packet step 604 which will filter out or ignore all packets subsequently received until the erroneous packet is re-received. The error flag remains set in all subsequent control packets, until the error is addressed by the output block re-sending the packet.

Although embodiments of the invention have been described within the context of a large multiprocessor system and Kautz topology, the invention may be applied to other system and topologies. Embodiments of the invention are directed to link layer error correction, and could be applied to any system where error correction is desired at the link level.

While the invention has been described in connection with certain preferred embodiments, it will be understood that it is not intended to limit the invention to those particular embodiments. On the contrary, it is intended to cover all alternatives, modifications and equivalents as may be included in the appended claims. Some specific figures and source code languages are mentioned, but it is to be understood that such figures and languages are, however, given as examples only and are not intended to limit the scope of this invention in any manner.

What is claimed is:

1. A method of providing in-order delivery of link-level packets in a multiprocessor computer system having a large plurality of processing nodes interconnected by a defined interconnection topology, comprising:
for a network transmission between a first node and a third node of the multiprocessor computer system, transmitting, over a link in the defined interconnection topology, a sequence of packets in a defined order from a first node to a second node, the second node being an intermediate node in a route between the first and the third node;
at the first node, storing the transmitted packets in a buffer;
at the first node, receiving status information from the second node indicating the last packet in the sequence correctly received by the second node and indicating that an error in reception has been detected by the second node;
the first node, retrieving packets from the buffer and re-transmitting them to the second node, beginning with the packet subsequent to the last packet in the sequence correctly received by the second node and continuing through the remainder of the sequence of packets.

2. The method of claim 1, wherein the large plurality of processing nodes are connected in a Kautz topology.

3. The method of claim 2, wherein the Kautz topology is of degree 3.

4. The method of claim 1, wherein packet transmission is on a unidirectional data link from the first node to the second node and wherein acknowledgements are received on a separate unidirectional control link from the second node to the first.

5. The method of claim 1, wherein acknowledgements are received periodically.

6. The method of claim 1, wherein an error in reception is detected using a CRC code.

7. The method of claim 1, wherein an error in reception is detected as an illegal 10 bit code.

8. A system for providing in-order delivery of link-level packets in a multiprocessor computer system having a large plurality of processing nodes interconnected by a defined interconnection topology, comprising:
a first node connected to a third node over a link in the defined interconnection topology;
a second node, which is an intermediate node in a route between the first node and the third node;
a buffer for storing a sequence of packets transmitted from the first node to the second node in a defined order;
status information, sent from the second node, comprising a sequence number of the last correctly received packet and a flag signaling that an error in reception has been detected by the second node,
wherein an error in reception signaled by the flag causes the first node to retrieve packets from the buffer and re-transmit them to the second node, beginning with the packet whose sequence number is subsequent to the sequence number of the last correctly received packet, and continuing through the remainder of the sequence of packets.

9. The system of claim 8, wherein the large plurality of processing nodes are connected in a Kautz topology.

10. The system of claim 8, wherein the Kautz topology is of degree 3.

11. The system of claim 8, wherein packet transmission is on a unidirectional data link from the first node to the second node and wherein acknowledgements are received on a separate unidirectional control link from the second node to the first.

12. The system of claim 8, wherein acknowledgements are received periodically.

13. The system of claim 8, wherein an error in reception is detected using a CRC code.

14. The system of claim 8, wherein an error in reception is detected as an illegal 10 bit code.
